(19) United States
(12) Patent Application Publication
(10) Pub. No.: US 2025/0212832 A1
(43) Pub. Date: Jul. 3, 2025

(54) COLLAPSIBLE ANIMAL CRATE

(71) Applicant: 2328634 Alberta Ltd., Edmonton (CA)

(72) Inventor: Kevin Byrne, Edmonton (CA)

(73) Assignee: 2328634 Alberta Ltd., Edmonton, AB (CA)

(21) Appl. No.: 18/398,652

(22) Filed: Dec. 28, 2023

(51) Int. Cl. A01K 1/00

(52) U.S. Cl. CPC A01K 1/0035

(57) ABSTRACT

An animal crate that is configured to receive and store an animal therein for the purpose of tasks such as but not limited to travel. The animal crate is operable to be moved intermediate a collapsed position and a deployed position. The invention includes a bottom member, a top member wherein the bottom member and top member have opposing sidewalls operably coupled intermediate thereto. A front wall member and a rear wall member are further present and are hingedly coupled to the bottom member so as to facilitate movement of the housing between its collapsed and stored position. The opposing sidewalls include a central hinge that divide the sidewalls into an upper portion and a lower portion and function to facilitate the inward folding of the opposing sidewalls. The front wall member includes a door hingedly secured thereto and the housing further has in each corner thereof a stacking member.

### FIELD OF THE INVENTION

The present invention relates generally to transport apparatus, more specifically but not by way of limitation, an animal crate that is configured to assist in the transportation and/or kenneling of an animal such as but not limited to a dog wherein the present invention is configured to transition between a deployed position to a folded position and is further constructed so as to facilitate vertical stacking thereof.

### BACKGROUND

Animal owners utilize apparatus referred to as kennels or transport cages for a variety of reasons for their animals. Some owners employ the devices for training purposes or utilize the kennels to temporarily house the animals. Conventional kennels are employed for transporting animals especially when the animal is being transported via air travel. The typical commercially available kennel is often manufactured from a lightweight durable material such as plastic wherein the walls include apertures to facilitate airflow through the kennel. The front of the kennel will have a hinged door that provides access to the interior volume of the kennel.

One issue with conventional dog kennels is their inability to be disassembled when not in use. A kennel for a large dog can be quite bulky and when not in use will consume a significant amount of storage space. Additionally, the design of a conventional dog crate does not facilitate an ability to securely stack multiple crates in a vertical manner. Furthermore, while conventional crates are somewhat durable, some are not compliant with airline regulations and cannot be utilized to transport animals on an airline.

Accordingly, there is a need for an animal crate that can be utilized to transport animals on an airline and employed for alternate uses wherein the animal crate of the present invention is configured to be collapsible when not in use so as to reduce storage space requirements.

### SUMMARY OF THE INVENTION

It is the object of the present invention to provide an animal crate that is configured to transition between a deployed position and a collapsed position wherein the present invention includes a housing having a bottom member and a top member.

Another object of the present invention is to provide an animal crate operable to assist in the housing and transport of an animal wherein the housing of the present invention includes opposing sidewalls wherein the opposing sidewalls have a central hinge member extending the length thereof intermediate the front edge and rear edge of the sidewalls.

A further object of the present invention is to provide an animal crate that is configured to transition between a deployed position and a collapsed position wherein the opposing sidewalls are hingedly coupled to the top member and bottom member of the housing.

Yet a further object of the present invention is to provide an animal crate operable to assist in the housing and transport of an animal wherein the opposing sidewalls further have releasably secured thereto in the deployed position a lateral spacing member wherein the lateral spacing member extends the length of the sidewall

Still another object of the present invention is to provide an animal crate that is configured to transition between a deployed position and a collapsed position wherein the upper surface of the top member includes stacking members in the corners of the top member.

An additional object of the present invention is to provide an animal crate operable to assist in the housing and transport of an animal wherein the stacking member includes a recess and a protuberance adjacent each other.

Yet a further object of the present invention is to provide an animal crate that is configured to transition between a deployed position and a collapsed position wherein the upper surface of the top member further includes recessed handles formed therein.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front perspective view of the present invention in a deployed state; and

FIG. 2 is a detailed view of the central hinge member of the sidewall; and

FIG. 3 is a detailed view of the stacking member of the present invention; and

FIG. 4 is a front view of the present invention in a deployed state; and

FIG. 5 is a side perspective view of the present invention in a deployed state; and

FIG. 6 is a perspective view of the present invention in a collapsed state; and

FIG. 7 is a rear perspective view of the present invention.

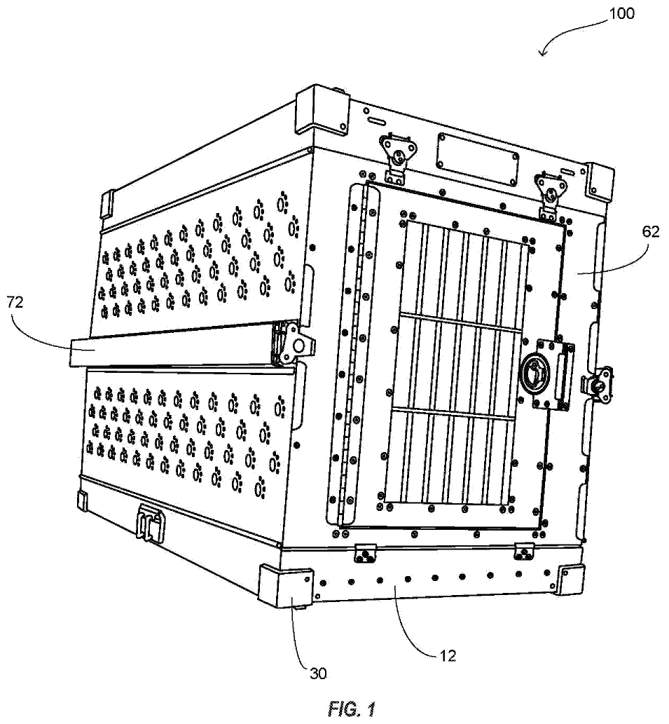

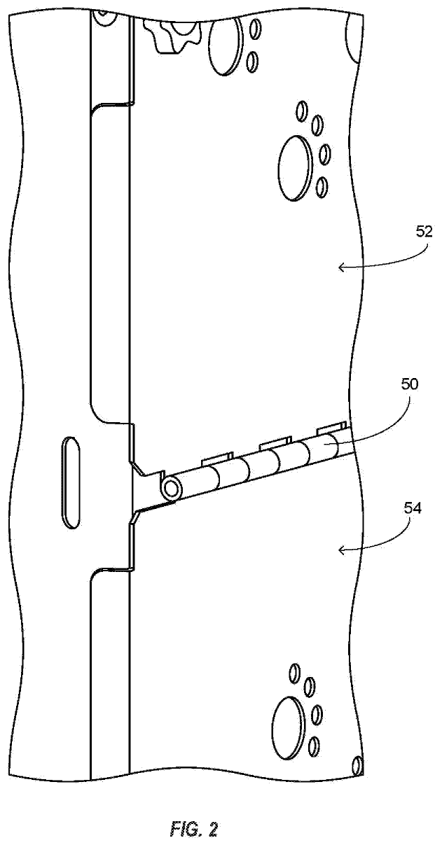

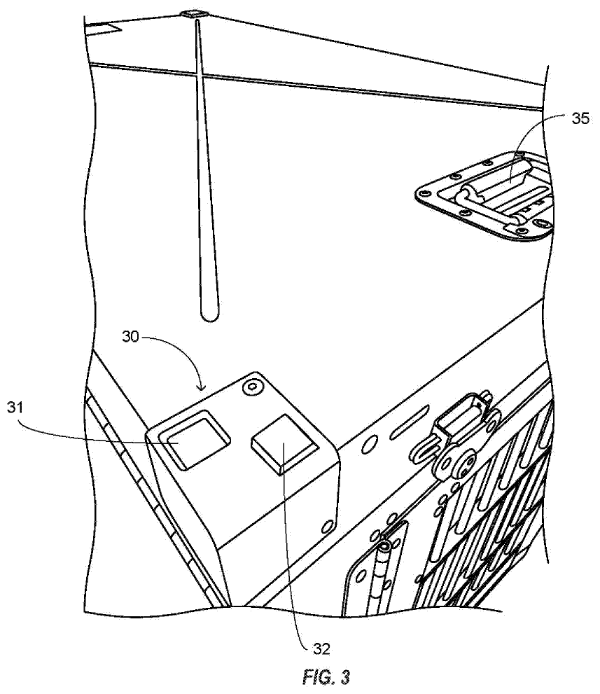

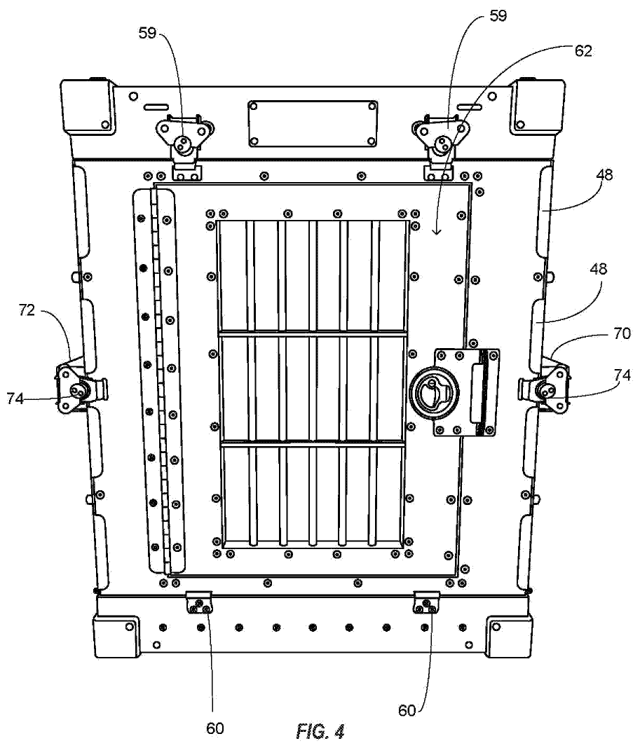

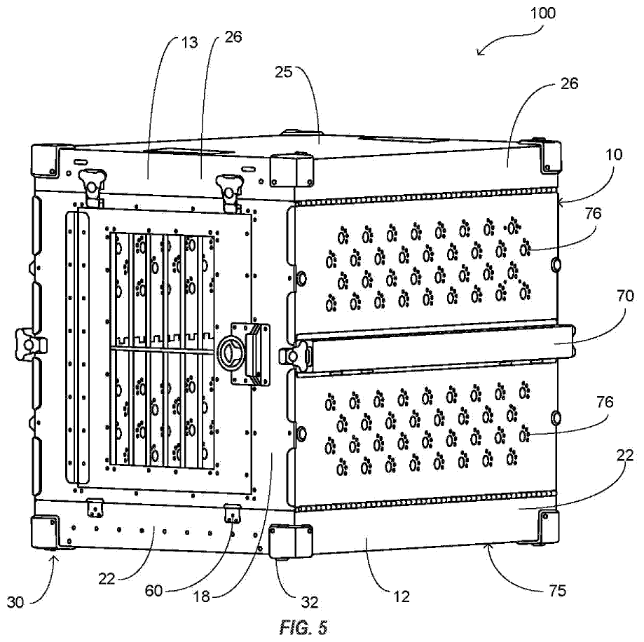

### DETAILED DESCRIPTION

Referring now to the drawings submitted herewith, wherein various elements depicted therein are not necessarily drawn to scale and wherein through the views and figures like elements are referenced with identical reference numerals, there is illustrated an animal crate 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

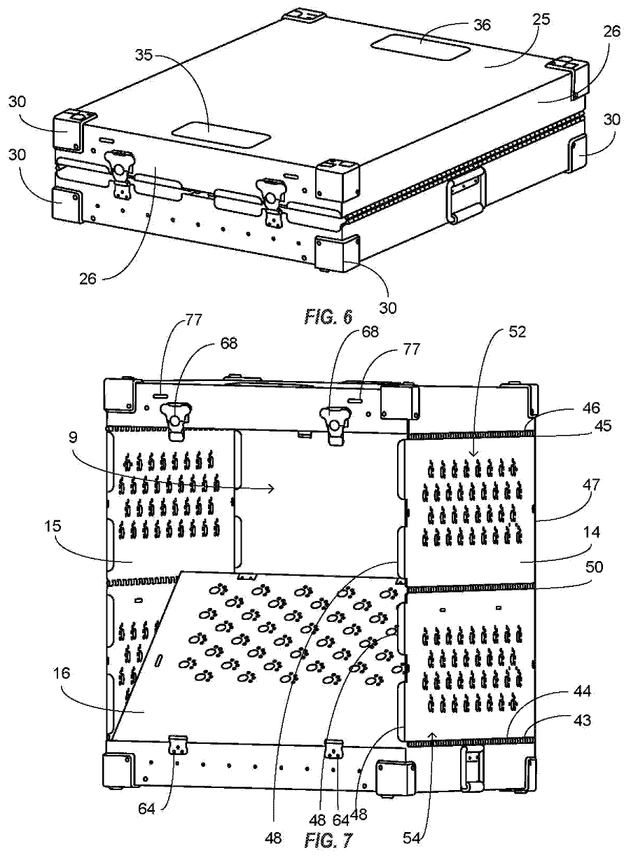

Referring in particular to the Figures submitted herewith, the animal crate 100 includes a housing 10 wherein the housing 10 is manufactured from a suitable durable material such as but not limited to aluminum. The housing 10 includes a bottom member 12, top member 13, opposing sidewalls 14,15, rear wall member 16 and front wall member 18 all operably coupled as is further discussed herein. The animal crate 100 is operable to house animals such as but not limited to dogs for various purposes such as but not limited to air travel. It should be understood within the scope of the present invention that the housing 10 could be provided in alternate sizes. The bottom member 12 is rectangular in shape having a floor member 20 wherein the floor member has integrally formed therewith side portions 22 wherein the side portions 22 extend upward from the floor member 20 being perpendicular thereto. The orientation of the side portions 22 create a small interior volume or void within the bottom member 12 that provides sufficient space and storage for the opposing sidewalls 14,15 when the housing 10 is in its collapsed position as is illustrated herein in FIG. 6.

The top member 13 includes top surface member 25 wherein the top surface member 25 has integrally formed therewith side portions 26 that extend downward therefrom being perpendicular thereto. The side portions 26 create a sufficient void wherein the void provides space for storage of the opposing sidewalls 14, 15, rear wall member 16 and front wall member 18 when the housing 10 is placed in its collapsed position. The top surface member 25 has secured in the corners thereof stacking members 30. The stacking members 30 are located at each corner of the top surface member 25 and the floor member 20. The stacking members 30 are operable to facilitate stacking of multiple animal crates 100 in a vertical orientation wherein the stacking members 30 provide mateable coupling of each vertically stacked animal crate 100. The stacking members 30 include a recess 31 and a protuberance 32 wherein the protuberance 32 aligns with a recess 31 of an adjacently stacked animal crate 100. While the stacking members 30 are illustrated herein on all four corners of the top surface member 25 and floor member 20, it is contemplated within the scope of the present invention that the animal crate 100 could employ less than four stacking members 30 on the top surface member 25 and floor member 20 that align in order to accomplish the desired objective discussed herein. The top surface member 25 further includes formed therein handle members 35,36. Handle members 35, 36 are recessed into the top surface member 25 so as to inhibit interference with an adjacent animal crate 100 when more than one animal crate 100 are stacked in a vertical orientation. It is contemplated within the scope of the present invention that the animal crate 100 could employ more or less than two handle members 35,36 formed in the top surface member 25.

The animal crate 100 includes opposing sidewalls 14,15 that are operably coupled intermediate the top member 13 and bottom member 12. The opposing sidewalls 14,15 are identically constructed and as such the ensuing discussion of sidewall 14 should be understood to be applicable to sidewall 15. Sidewall 14 includes a bottom edge 43 wherein the bottom edge 43 includes a bottom hinge member 44 present along the length thereof. A top edge 45 is present wherein the top edge 45 includes a top hinge member 46 present along the entire length of the top edge 45. The sidewall 14 includes a rear edge 42 and a front edge 47 wherein the rear edge 42 and front edge 47 include tab members 48 that are operably to assist in placement and engagement of the rear wall member 16 and front wall member 18 when the animal crate 100 is in its deployed position. The tab members 48 are integrally formed with the sidewall 14 and are perpendicular thereto extending inward towards the opposing sidewall. Sidewall 14 includes central hinge member 50 wherein the central hinge member 50 extends intermediate the rear edge 42 and front edge 47. The central hinge member 50 divides the sidewall 14 into an upper portion 52 and lower portion 54. The central hinge member 50 in combination with the top hinge member 46 and bottom hinge member 44 function to fold the sidewall 14 in a manner wherein the sidewall 14 collapses inward so as to permit the top member 13 to be moved downwards towards the bottom member 12 to move the animal crate 100 to its collapsed position.

The front wall member 18 is hingedly coupled to the bottom member 12 and is configured to be folded inward towards the interior volume of the animal crate 100 utilizing hinges 60. The front wall member 18 includes door member 62 wherein the door member 62 is hingedly coupled to the front wall 18 and is configured to be operably moved between an open position and a closed position to facilitate movement of an animal in and out of the animal crate 100. The front wall member 18 is secured in position to place the animal crate 100 in its deployed position with locking members 59. Locking members 59 are configured to engage apertures formed in the side portions 26 and lock the front wall member 18 into position maintaining the animal crate 100 in its deployed state.

Rear wall member 16 is hingedly coupled to side portion 22 employing hinge members 64. The rear wall member 16 is configured to be folded inwards into the interior volume 9 of the housing 10 so as to facilitate the animal crate 100 being moved from its deployed state to its collapsed state. Rear wall member 16 is maintained in its upright position with locking members 68 and wherein locking members 68 further facilitate the releasable securing of the top member 13 to bottom member 12 when the animal crate 100 is placed in its collapsed position.

The animal crate 100 includes a first lateral spacing member 70 and a second lateral spacing member 72. The first lateral spacing member 70 and second lateral spacing member 72 are rectangular in shape being elongated in form so as to extend along the sidewalls 14,15 intermediate the front wall member 18 and rear wall member 16. The first lateral spacing member 70 and second lateral spacing member 72 includes keepers 74 on each end thereof wherein the keepers 74 function to releasably secure the first lateral spacing member 70 and second lateral spacing member 72 to the housing 10 in a first position and a second position. In the first position, the first lateral spacing member 70 and second lateral spacing member 72 are secured over the central hinge member 50 and the thickness thereof provides sufficient spacing against an adjacent object so as to ensure maintenance of airflow through apertures 76. When the animal crate 100 is in its collapsed position, the keepers 74 are employed to secure the first lateral spacing member 70 and second lateral spacing member 72 over the top member 13 wherein the keepers 74 operably engage with apertures 77 formed in the side portion 26 of the top member 13.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An animal crate comprising:
a housing, said housing having a bottom member, a top member, a first sidewall, a second side wall, a front wall member and a rear wall member being operably coupled to form an interior volume, said housing being configured to have a collapsed position and a deployed position, said bottom member having four corners, said bottom member having a floor member, said bottom member having four side portions integrally formed with said floor member, said four side portions extending upward from said floor member around a perimeter edge thereof, said four side portions being perpendicular to said floor member, said top member having four corners, said top member including a top surface member, said top surface member being planar in manner, said top surface member having a perimeter edge, said top surface member having four side portions integrally formed therewith wherein the four side portions of said top surface member extend downward therefrom being perpendicular thereto, said rear wall being hingedly secured to said bottom member proximate a lower edge thereof, said rear wall member configured to be folded into said bottom member when said housing is in said collapsed position, said front wall member being hingedly coupled to a front side portion of said bottom member, said front wall member configured to be folded into said bottom member when said housing is in said collapsed position, said first sidewall being hingedly coupled to a first side portion of said top member proximate a top edge of said first sidewall, said first sidewall being hingedly coupled to a first side portion of said bottom member proximate a lower edge of said first sidewall, said first sidewall having a central hinge member proximate a midpoint thereof, said central hinge member operable to divide said first sidewall into an upper portion and a lower portion, said upper portion and said lower portion of said first sidewall configured to fold into said bottom member when said housing is in said collapsed position, said second sidewall being hingedly coupled to a second side portion of said top member proximate a top edge of said second sidewall, said second sidewall being hingedly coupled to a second side portion of said bottom member proximate a lower edge of said second sidewall, said second sidewall having a central hinge member proximate a midpoint thereof, said central hinge member of said second sidewall operable to divide said second sidewall into an upper portion and a lower portion, said upper portion and said lower portion of said second sidewall configured to fold into said bottom member when said housing is in said collapsed position.

2. The animal crate as recited in claim 1, wherein said front wall member further includes a door member, said door member being hingedly coupled to said front wall member, said door member operable to be moved intermediate a closed position and an open position.

3. The animal crate as recited in claim 2, and further including stacking members, said stacking members being coupled to said four corners of said top member and said four corners of said bottom member, said stacking members further including a recess and a protuberance.

4. The animal crate as recited in claim 3, wherein said top surface member further includes at least one recessed handle formed in an outer surface thereof.

5. The animal crate as recited in claim 4, and further including a first lateral spacing member, said first lateral spacing member being rectangular in shape and elongated in form, said first lateral spacing member being operably coupled over said central hinge member of said first sidewall when said housing is in said deployed position.

6. The animal crate as recited in claim 5, and further including a second lateral spacing member, said second lateral spacing member being rectangular in shape and elongated in form, said second lateral spacing member being operably coupled over said central hinge member of said second sidewall when said housing is in said deployed position.

7. The animal crate as recited in claim 6, wherein a front side portion of said top member further includes a first aperture and a second aperture formed therein.

8. The animal crate as recited in claim 7, wherein a rear side portion of said top member further includes a first aperture and a second aperture formed therein.

9. The animal crate as recited in claim 8, wherein said first aperture and second apertures of said rear side portion and front side portion of said top member are configured to operably couple with locking members present on a first end and a second end of said first lateral spacing member and the second lateral spacing member.

10. The animal crate as recited in claim 9, wherein the front side portion of the top member includes a first locking member and a second locking member configured to secure said front wall member when said housing is in said deployed position.

11. The animal crate as recited in claim 10, wherein the rear side portion of the top member includes a first locking member and a second locking member configured to secure said rear wall member when said housing is in said deployed position.
